(19) United States
(12) Patent Application Publication
(10) Pub. No.: US 2007/0020457 A1
(43) Pub. Date: Jan. 25, 2007

(54) Composite particle comprising an abrasive grit

(75) Inventor: Negus B. Adefris, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/186,219

(22) Filed: Jul. 21, 2005

(51) Int. Cl. B24D 3/02; B32B 1/00; B32B 18/00

(52) U.S. Cl. 428/403; 51/307; 51/308; 51/309

(57) ABSTRACT

Composite particle having an abrasive grit with a ceramic material thereon. Composite particles can be incorporated, for example, into a variety of abrasive articles.

### BACKGROUND

Bonded (typically metal bonded, resin bonded, and vitrified bonded) abrasive articles (e.g., wheels) are commonly used for abrading workpiece surfaces (e.g., metals, plastics, and ceramics). These bonded abrasive abrasives are made using a variety of abrasive particles, including extremely hard abrasive particles sometimes referred to as “superabrasive” (e.g., cubic boron nitride (CBN) and diamond) particles or grits. Such superabrasive particles have a relatively high thermal conductivity (typically at least about 0.03 cal/sec/cm/° C.). As such, superabrasive particles are employed to advantage in abrasive processes that require that work-generated heat be conducted away from the workpiece interface. While this feature has obvious advantages, it also causes thermal energy to be transferred through the conductive particles to the bonded material. This thermal transfer can cause bond failure due to softening or degradation of the bond at the particle interface, leading to a reduced useful life of the bonded abrasive article. It is desirable to prevent, or at least reduce, such thermally-induced performance degradation of these type of bonded abrasive articles.

### SUMMARY OF THE INVENTION

In one aspect, the present invention provides a composite particle(s) comprising a single abrasive grit having an outer surface, and a ceramic (typically crystalline ceramics and glass-ceramics) substantially covering the outer surface, wherein the abrasive grit has, at 400° C., a thermal conductivity of at least 0.03 cal/sec/cm/° C., wherein the ceramic has, in a range 400° C. to 1600° C., a thermal conductivity that is at least 50% less than the thermal conductivity of the abrasive grit, and wherein the ceramic has a thickness in a range from 10 nm to 1000 nm. In this application, an abrasive grit has an average hardness of at least 15 GPa; in some embodiments, an average hardness of at least 16 GPa, 17 GPa, 18 GPa, 19 GPa, or even at least 20 GPa. Exemplary single abrasive grits include boron nitride grits, diamond grits, boron nitride carbide (BNC) grits, polycrystalline diamond grits, and polycrystalline cubic boron nitride grits. Exemplary ceramics include crystalline metal oxides and crystalline metal carbides.

In another aspect, the present invention provides a method for preparing a composite particle(s) according to the present invention, the method comprising:

providing an abrasive grit(s) having an outer surface, wherein the abrasive grit(s) has, at 400° C., a thermal conductivity of at least 0.03 cal/sec/cm/° C.; and

applying a ceramic to substantially cover the outer surface to provide the composite particle(s).

Abrasive particles are usually graded to a given particle size distribution before use. Such distributions typically have a range of particle sizes, from coarse particles fine particles. In the abrasive art this range is sometimes referred to as a “coarse”, “control” and “fine” fractions. Abrasive particles graded according to industry accepted grading standards specify the particle size distribution for each nominal grade within numerical limits. Such industry accepted grading standards (i.e., specified nominal grades) include those known as the American National Standards Institute, Inc. (ANSI) standards, Federation of European Producers of Abrasive Products (FEPA) standards, and Japanese Industrial Standard (JIS) standards. In one aspect, the present invention provides a plurality of abrasive particles having a specified nominal grade, wherein at least a portion of the plurality of abrasive particles are abrasive particles according to the present invention. In another aspect, the present invention provides a plurality of abrasive grits having a specified nominal grade, wherein at least a portion of the abrasive grits is a plurality of the composite particles according to the present invention or the single grits in the composite particles according to the present invention.

Composite particles according to the present invention are useful, for example, in abrasive articles. Abrasive articles according to the present invention comprise binder and a plurality of abrasive particles, wherein at least a portion of the abrasive particles are the composite particles according to the present invention. Exemplary abrasive products include coated abrasive articles, bonded abrasive articles (e.g., wheels), non-woven abrasive articles, and abrasive brushes. Coated abrasive articles typically comprise a backing having first and second, opposed major surfaces, and wherein the binder and the plurality of abrasive particles form an abrasive layer on at least a portion of the first major surface.

In some embodiments, at least 5, 10, 15, 20, 25, 30, 35, 40, 45, 50 55, 60, 65, 70, 75, 80, 85, 90, 95, or even 100 percent by weight of the abrasive particles in an abrasive article are the composite particles according to the present invention, based on the total weight of the abrasive particles in the abrasive article.

In another aspect, the present invention provides methods for making abrasive articles. For example, one method comprises applying a slurry comprising a plurality of composite particles according to the present invention distributed within a binder precursor onto a major surface of a backing to provide a layer of the slurry, and curing the binder precursor to provide the abrasive article. Another method comprises applying a make layer onto a major surface of a backing, at least partially embedding a plurality of composite particles according to the present invention into the make layer, at least partially curing the make layer, applying a size layer at least partially covering the cured make layer, and curing the size layer to provide the abrasive article.

In another aspect, the present invention provides a method of abrading a surface, the method comprising:

providing an abrasive article comprising a binder and a plurality of abrasive particles, wherein at least a portion of the abrasive particles is a plurality of composite particles according to the present invention;

contacting at least one of the composite particles with a surface of a workpiece; and

moving at least one of the contacted composite particles or the contacted surface to abrade at least a portion of the surface with the contacted composite particles.

Embodiments of abrasive articles comprising composite particles according to the present invention have been observed to exhibit increased abrasive life and decreased shelling. Embodiments of abrasive articles comprising composite particles according to the present invention have also been observed to exhibit reduced premature failure of the bond post as a result of heat related damage.

### BRIEF DESCRIPTION OF THE DRAWING

FIG. 1 is a fragmentary cross-sectional schematic view of an exemplary coated abrasive article including exemplary composite particles according to the present invention.

FIG. 2 is a perspective view of an exemplary bonded abrasive article including exemplary composite particles according to the present invention.

### DETAILED DESCRIPTION

In some embodiments, the abrasive grit has a thermal conductivity of at least 0.3 cal/sec/cm/° C., at least 0.35 cal/sec/cm/° C., 0.4 cal/sec/cm/° C., 0.45 cal/sec/cm/° C., 0.5 cal/sec/cm/° C., 0.75 cal/sec/cm/° C., 1 cal/sec/cm/° C., 1.5 cal/sec/cm/° C., or even at least 2 cal/sec/cm/° C. Exemplary abrasive grits for making composite particles according to the invention include boron nitride grits, diamond grits, boron nitride carbide (BNC) grits, polycrystalline diamond grits, and polycrystalline cubic boron nitride grits. Typically, the single abrasive grit has an average particle size in the range from 0.1 micrometer to 1000 micrometers; in some embodiments, in the range from 1 micrometer to 500 micrometers; and in other embodiments 20 micrometers to 400 micrometers.

Exemplary ceramics substantially covering the outer surface of the abrasive grit (i.e., at least 80 (in some embodiments at least 85, 90, 95, or even in some embodiments about 100) percent by area of the abrasive grit is covered), have, in a range 400° C. to 1600° C., a thermal conductivity of not greater than 0.02 cal/sec/cm/° C., 0.01 cal/sec/cm/° C., 0.005 cal/sec/cm/° C., 0.001 cal/sec/cm/° C., 0.0005 cal/sec/cm/° C., or even not greater than 0.0001 cal/sec/cm/° C. Exemplary ceramics substantially covering the outer surface of the abrasive grit include crystalline metal oxides and crystalline metal carbides. Specific exemplary ceramics substantially covering the outer surface of the abrasive grit include Al₂O₃, porcelain, ZrO₂, and MgO.

In some embodiments, the ceramics have an average thickness in a range from 10 nm to 500 nm, 10 nm to 200 nm, 10 nm to 100 nm, 10 nm to 50 nm, 10 nm to 25 nm. In some embodiments, the amount of ceramic is not greater than 5 (in some embodiments, not greater than 4, 3, or even not greater than 2) percent by weight of the weight of the single abrasive grit.

The ceramic can be applied to the outer surface of the abrasive grit using techniques known in the art, such as plasma spraying, fluidized bed coating, sputter coating, vapor deposition, and/or physical deposition (e.g., by applying a slurry of ceramic precursor, drying, and firing to convert the ceramic precursor to ceramic).

Abrasive grits and composite particles according to the present invention can be screened and graded using techniques well known in the art, including the use of industry recognized grading standards such as ANSI (American National Standard Institute), FEPA (Federation Europeenne des Fabricants de Products Abrasifs), and JIS (Japanese Industrial Standard).

ANSI grade designations include: ANSI 4, ANSI 6, ANSI 8, ANSI 16, ANSI 24, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600. FEPA grade designations include P8, P12, P16, P24, P36, P40, P50, P60, P80, P100, P120, P150, P180, P220, P320, P400, P500, P600, P800, P1000, and P1200. JIS grade designations include JIS8, JIS12, JIS16, JIS24, JIS36, JIS46, JIS54, JIS60, JIS80, JIS1000, JIS150, JIS180, JIS220, JIS240, JIS280, JIS320, JIS360, JIS400, JIS600, JIS800, JIS1000, JIS1500, JIS2500, JIS4000, JIS6000, JIS8000, and JIS10,000.

Optionally, composite abrasive particles according to the present invention can be made into agglomerates using techniques known in the art.

In another aspect, the present invention provides an abrasive article (e.g., coated abrasive articles, bonded abrasive articles (including vitrified, resinoid, and metal bonded grinding wheels, cutoff wheels, mounted points, and honing stones), nonwoven abrasive articles, and abrasive brushes) comprising a binder and a plurality of abrasive particles, wherein at least a portion of the abrasive particles are composite particles (including where the composite particles are agglomerated) according to the present invention. Methods of making such abrasive articles and using abrasive articles are well known to those skilled in the art.

Coated abrasive articles generally include a backing, abrasive particles, and at least one binder to hold the composite particles onto the backing. The backing can be any suitable material, including cloth, polymeric film, fibre, nonwoven webs, paper, combinations thereof, and treated versions thereof. The binder can be any suitable binder, including an inorganic or organic binder (including thermally curable resins and radiation curable resins). The composite particles can be present in one layer or in multiple (e.g., two) layers of the coated abrasive article.

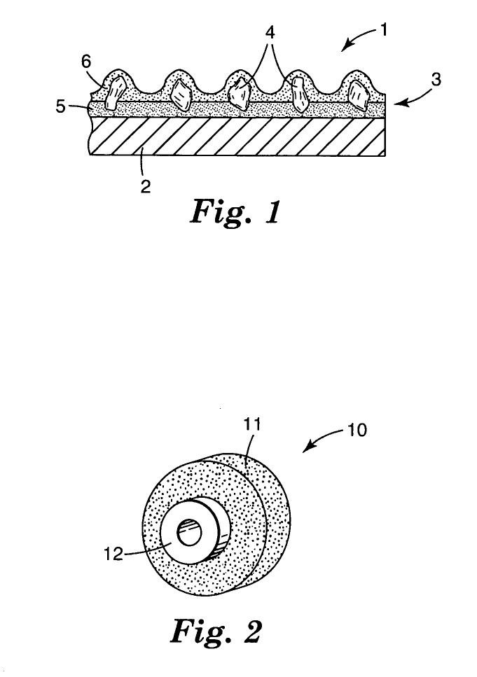

An example of a coated abrasive article according to the present invention is depicted in FIG. 1. Referring to this figure, coated abrasive article according to the present invention 1 has a backing (substrate) 2 and abrasive layer 3. Abrasive layer 3 includes composite particles according to the present invention 4 secured to a major surface of backing 2 by make coat 5 and size coat 6. In some instances, a supersize coat (not shown) is used.

Bonded abrasive articles typically include a shaped mass of composite particles held together by an organic, metallic, or vitrified binder. Such shaped mass can be, for example, in the form of a wheel, such as a grinding wheel or cutoff wheel. The diameter of grinding wheels typically is about 1 cm to over 1 meter; the diameter of cutoff wheels about 1 cm to over 80 cm (more typically 3 cm to about 50 cm). The grinding wheel thickness is typically about 1 mm to about 10 cm, more typically about 2 mm to about 5 cm. The cutoff wheel thickness is typically about 0.015 mm to about 5 cm, more typically about 0.025 mm to about 2 cm. The shaped mass can also be in the form, for example, of a honing stone, segment, mounted point, disc (e.g., double disc grinder) or other conventional bonded abrasive shape. Bonded abrasive articles typically comprise about 5-40% by volume bond material, about 12-80% by volume composite particles (or composite/abrasive particle blends), up to 50% by volume additives (including grinding aids), and up to 40% by volume pores, based on the total volume of the bonded abrasive article.

The abrasive particles in the abrasive articles can be 100% composite particles according to the present invention, or blends of such abrasive particles with other (secondary) abrasive particles and/or diluent particles. However, desirably about 25-100% by weight, of the abrasive particles in the abrasive articles should be composite particles according to the present invention. In some instances, the composite particles according the present invention may be blended with another abrasive particles and/or diluent particles at a ratio between 5 to 75% by weight, about 25 to 75% by weight about 40 to 60% by weight, or about 50% to 50% by weight (i.e., in equal amounts by weight). Examples of suitable conventional abrasive particles include fused aluminum oxide (including white fused alumina, heat-treated aluminum oxide and brown aluminum oxide), silicon carbide, boron carbide, titanium carbide, diamond, cubic boron nitride, gamet, fused alumina-zirconia, and sol-gel-derived abrasive particles, and the like. The sol-gel-derived abrasive particles may be seeded or non-seeded. Likewise, the sol-gel-derived abrasive particles may be randomly shaped or have a shape associated with them, such as a rod or a triangle. Examples of sol-gel abrasive particles include those described U.S. Pat. No. 4,314,827 (Leitheiser et al.), U.S. Pat. No. 4,518,397 (Leitheiser et al.), U.S. Pat. No. 4,623,364 (Cottringer et al.), U.S. Pat. No. 4,744,802 (Schwabel), U.S. Pat. No. 4,770,671 (Monroe et al.), U.S. Pat. No. 4,881,951 (Wood et al.), U.S. Pat. No. 5,011,508 (Wald et al.), U.S. Pat. No. 5,090,968 (Pellow), U.S. Pat. No. 5,139,978 (Wood), U.S. Pat. No. 5,201,916 (Berg et al.), U.S. Pat. No. 5,227,104 (Bauer), U.S. Pat. No. 5,366,523 (Rowenhorst et al.), U.S. Pat. No. 5,429,647 (Larmie), U.S. Pat. No. 5,498,269 (Larmie), and U.S. Pat. No. 5,551,963 (Larmie). Additional details concerning sintered alumina abrasive particles made by using alumina powders as a raw material source can also be found, for example, in U.S. Pat. No. 5,259,147 (Falz), U.S. Pat. No. 5,593,467 (Monroe), and U.S. Pat. No. 5,665,127 (Moltgen). Additional details concerning fused abrasive particles, can be found, for example, in U.S. Pat. No. 1,161,620 (Coulter), U.S. Pat. No. 1,192,709 (Tone), U.S. Pat. No. 1,247,337 (Saunders et al.), U.S. Pat. No. 1,268,533 (Allen), and U.S. Pat. No. 2,424,645 (Baumann et al.) U.S. Pat. No. 3,891,408 (Rowse et al.), U.S. Pat. No. 3,781,172 (Pett et al.), U.S. Pat. No. 3,893,826 (Quinan et al.), U.S. Pat. No. 4,126,429 (Watson), U.S. Pat. No. 4,457,767 (Poon et al.), U.S. Pat. No. 5,023,212 (Dubots et. al), U.S. Pat. No. 5,143,522 (Gibson et al.), U.S. Pat. No. 5,336,280 (Dubots et. al), U.S. Pat. No. 6,706,083 (Rosenflanz), U.S. Pat. No. 6,666,750 (Rosenflanz), U.S. Pat. No. 6,596,041 (Rosenflanz), U.S. Pat. No. 6,589,305 (Rosenflanz), U.S. Pat. No. 6,583,080 (Rosenflanz), U.S. Pat. No. 6,582,488 (Rosenflanz), U.S. Pat. No. 6,458,731 (Rosenflanz), U.S. Pat. No. 6,454,822 (Rosenflanz), U.S. Pat. No. 6,451,077 (Rosenflanz), U.S. Pat. No. 6,592,640 (Rosenflanz et al.), U.S. Pat. No. 6,607,570 (Rosenflanz et al.), and U.S. Pat. No. 6,669,749 (Rosenflanz et al.). In some instances, blends of abrasive particles may result in an abrasive article that exhibits improved grinding performance in comparison with abrasive articles comprising 100% of either type of abrasive particle.

An exemplary form is a grinding wheel. Referring to FIG. 2, grinding wheel according to the present invention 10 is depicted, which includes composite particles according to the present invention 11, molded in a wheel and mounted on hub 12.

Nonwoven abrasive articles typically include an open porous lofty polymer filament structure having composite particles according to the present invention distributed throughout the structure and adherently bonded therein by an organic binder. Examples of filaments include polyester fibers, polyamide fibers, and polyaramid fibers.

Useful abrasive brushes include those having a plurality of bristles unitary with a backing (see, e.g., U.S. Pat. No. 5,427,595 (Pihl et al.), U.S. Pat. No. 5,443,906 (Pihl et al.), U.S. Pat. No. 5,679,067 (Johnson et al.), and U.S. Pat. No. 5,903,951 (Ionta et al.)). Desirably, such brushes are made by injection molding a mixture of polymer and composite particles.

Suitable organic binders for making abrasive articles include thermosetting organic polymers. Examples of suitable thermosetting organic polymers include phenolic resins, urea-formaldehyde resins, melamine-formaldehyde resins, urethane resins, acrylate resins, polyester resins, aminoplast resins having pendant α,β-unsaturated carbonyl groups, epoxy resins, acrylated urethane, acrylated epoxies, and combinations thereof. The binder and/or abrasive article may also include additives such as fibers, lubricants, wetting agents, thixotropic materials, surfactants, pigments, dyes, antistatic agents (e.g., carbon black, vanadium oxide, graphite, etc.), coupling agents (e.g., silanes, titanates, zircoaluminates, etc.), plasticizers, suspending agents, and the like. The amounts of these optional additives are selected to provide the desired properties. The coupling agents can improve adhesion to the composite particles (other, additional abrasive particles) and/or filler. The binder chemistry may thermally cured, radiation cured or combinations thereof. Additional details on binder chemistry may be found in U.S. Pat. No. 4,588,419 (Caul et al.), U.S. Pat. No. 4,751,138 (Tumey et al.), and U.S. Pat. No. 5,436,063 (Follett et al.).

More specifically with regard to vitrified bonded abrasives, vitreous bonding materials, which exhibit an amorphous structure and are typically hard, are well known in the art. In some cases, the vitreous bonding material includes crystalline phases. Bonded, vitrified abrasive articles according to the present invention may be in the shape of a wheel (including cut off wheels), honing stone, mounted pointed or other conventional bonded abrasive shape. An exemplary vitrified bonded abrasive article according to the present invention is a grinding wheel.

Examples of metal oxides that are used to form vitreous bonding materials include: silica, silicates, alumina, soda, calcia, potassia, titania, iron oxide, zinc oxide, lithium oxide, magnesia, boria, aluminum silicate, borosilicate glass, lithium aluminum silicate, combinations thereof, and the like. Typically, vitreous bonding materials can be formed from composition comprising from 10 to 100% glass frit, although more typically the composition comprises 20% to 80% glass frit, or 30% to 70% glass frit. The remaining portion of the vitreous bonding material can be a non-frit material. Alternatively, the vitreous bond may be derived from a non-frit containing composition. Vitreous bonding materials are typically matured at a temperature(s) in a range of about 700° C. to about 1500° C., usually in a range of about 800° C. to about 1300° C., sometimes in a range of about 900° C. to about 1200° C., or even in a range of about 950° C. to about 1100° C. The actual temperature at which the bond is matured depends, for example, on the particular bond chemistry.

In some embodiments, vitrified bonding materials may include those comprising silica, alumina (desirably, at least 10 percent by weight alumina), and boria (desirably, at least 10 percent by weight boria). In most cases the vitrified bonding material further comprise alkali metal oxide(s) (e.g., Na₂O and K₂O) (in some cases at least 10 percent by weight alkali metal oxide(s)).

Binder materials may also contain filler materials or grinding aids, typically in the form of a particulate material. Typically, the particulate materials are inorganic materials. Examples of useful fillers for this invention include: metal carbonates (e.g., calcium carbonate (e.g., chalk, calcite, marl, travertine, marble and limestone), calcium magnesium carbonate, sodium carbonate, magnesium carbonate), silica (e.g., quartz, glass beads, glass bubbles and glass fibers) silicates (e.g., talc, clays, (montmorillonite) feldspar, mica, calcium silicate, calcium metasilicate, sodium aluminosilicate, sodium silicate) metal sulfates (e.g., calcium sulfate, barium sulfate, sodium sulfate, aluminum sodium sulfate, aluminum sulfate), gypsum, vermiculite, wood flour, aluminum trihydrate, carbon black, metal oxides (e.g., calcium oxide (lime), aluminum oxide, titanium dioxide), and metal sulfites (e.g., calcium sulfite).

In general, the addition of a grinding aid increases the useful life of the abrasive article. A grinding aid is a material that has a significant effect on the chemical and physical processes of abrading, which results in improved performance. Although not wanting to be bound by theory, it is believed that a grinding aid(s) (a) decreases the friction between the composite particles (and other, additional abrasive particles) and the workpiece being abraded, (b) prevents the composite particles (and other, additional abrasive particles) from “capping” (i.e., prevent metal particles from becoming welded to the tops of the composite particles (and other, additional abrasive particles)), or at least reduce the tendency of composite particles (and other, additional abrasive particles) to cap, (c) decreases the interface temperature between the composite particles (and other, additional abrasive particles) and the workpiece, or (d) decreases the grinding forces.

Grinding aids encompass a wide variety of different materials and can be inorganic or organic based. Examples of chemical groups of grinding aids include waxes, organic halide compounds, halide salts and metals and their alloys. The organic halide compounds will typically break down during abrading and release a halogen acid or a gaseous halide compound. Examples of such materials include chlorinated waxes like tetrachloronaphtalene, pentachloronaphthalene, and polyvinyl chloride. Examples of halide salts include sodium chloride, potassium cryolite, sodium cryolite, ammonium cryolite, potassium tetrafluoroboate, sodium tetrafluoroborate, silicon fluorides, potassium chloride, and magnesium chloride. Examples of metals include, tin, lead, bismuth, cobalt, antimony, cadmium, and iron titanium. Other miscellaneous grinding aids include sulfur, organic sulfur compounds, graphite, and metallic sulfides. It is also within the scope of the present invention to use a combination of different grinding aids, and in some instances this may produce a synergistic effect. Desirable grinding aids include cryolite and potassium tetrafluoroborate.

Grinding aids can be particularly useful in coated abrasive and bonded abrasive articles. In coated abrasive articles, grinding aid is typically used in the supersize coat, which is applied over the surface of the composite particles (and other, additional abrasive particles). Sometimes, however, the grinding aid is added to the size coat. Typically, the amount of grinding aid incorporated into coated abrasive articles are about 50-300 g/m² (desirably, about 80-160 g/m²). In vitrified bonded abrasive articles grinding aid is typically impregnated into the pores of the article.

If there is a blend of abrasive particles, the abrasive particle types forming the blend may be of the same size. Alternatively, the abrasive particle types may be of different particle sizes. For example, the larger sized abrasive particles may be composite particles according to the present invention, with the smaller sized particles being another abrasive particle type. Conversely, for example, the smaller sized abrasive particles may be composite particles according to the present invention, with the larger sized particles being another abrasive particle type.

Examples of suitable diluent particles include marble, gypsum, flint, silica, iron oxide, aluminum silicate, glass (including glass bubbles and glass beads), alumina bubbles, alumina beads and diluent agglomerates. Composite particles according to the present invention can also be combined in or with abrasive agglomerates. Abrasive agglomerate particles typically comprise a plurality of abrasive particles, a binder, and optional additives. The binder may be organic and/or inorganic. Abrasive agglomerates may be randomly shape or have a predetermined shape associated with them. The shape may be a block, cylinder, pyramid, coin, square, or the like. Abrasive agglomerate particles typically have particle sizes ranging from about 100 to about 5000 micrometers, typically about 250 to about 2500 micrometers. Additional details regarding abrasive agglomerate particles may be found, for example, in U.S. Pat. No. 4,311,489 (Kressner), U.S. Pat. No. 4,652,275 (Bloecher et al.), U.S. Pat. No. 4,799,939 (Bloecher et al.), U.S. Pat. No. 5,549,962 (Holmes et al.), and U.S. Pat. No. 5,975,988 (Christianson), U.S. Pat. No. 6,521,004, (Culler et al.), and U.S. Pat. No. 6,620,214 (McArdle et al.).

The composite/abrasive particles may be uniformly distributed in the abrasive article or concentrated in selected areas or portions of the abrasive article. For example, in a coated abrasive, there may be two layers of abrasive particles. The first layer comprises abrasive particles other than composite particles according to the present invention, and the second (outermost) layer comprises composite particles according to the present invention. Likewise in a bonded abrasive, there may be two distinct sections of the grinding wheel. For example, the outermost section may comprise composite particles according to the present invention, whereas the innermost section does not. Alternatively, for example, composite particles according to the present invention may be uniformly distributed throughout the bonded abrasive article.

Further details regarding coated abrasive articles can be found, for example, in U.S. Pat. No. 4,734,104 (Broberg), U.S. Pat. No. 4,737,163 (Larkey), U.S. Pat. No. 5,203,884 (Buchanan et al.), U.S. Pat. No. 5,152,917 (Pieper et al.), U.S. Pat. No. 5,378,251 (Culler et al.), U.S. Pat. No. 5,417,726 (Stout et al.), U.S. Pat. No. 5,436,063 (Follett et al.), U.S. Pat. No. 5,496,386 (Broberg et al.), U.S. Pat. No. 5,609,706 (Benedict et al.), U.S. Pat. No. 5,520,711 (Helmin), U.S. Pat. No. 5,954,844 (Law et al.), U.S. Pat. No. 5,961,674 (Gagliardi et al.), and U.S. Pat. No. 5,975,988 (Christinason). Further details regarding bonded abrasive articles can be found, for example, in U.S. Pat. No. 4,543,107 (Rue), U.S. Pat. No. 4,741,743 (Narayanan et al.), U.S. Pat. No. 4,800,685 (Haynes et al.), U.S. Pat. No. 4,898,597 (Hay et al.), U.S. Pat. No. 4,997,461 (Markhoff-Matheny et al.), U.S. Pat. No. 5,037,453 (Narayanan et al.), U.S. Pat. No. 5,110,332 (Narayanan et al.), and U.S. Pat. No. 5,863,308 (Qi et al.). Further details regarding vitreous bonded abrasives can be found, for example, in U.S. Pat. No. 4,543,107 (Rue), U.S. Pat. No. 4,898,597 (Hay et al.), U.S. Pat. No. 4,997,461 (Markhoff-Matheny et al.), U.S. Pat. No. 5,094,672 (Giles Jr. et al.), U.S. Pat. No. 5,118,326 (Sheldon et al.), U.S. Pat. No. 5,131,926 (Sheldon et al.), U.S. Pat. No. 5,203,886 (Sheldon et al.), U.S. Pat. No. 5,282,875 (Wood et al.), U.S. Pat. No. 5,738,696 (Wu et al.), and U.S. Pat. No. 5,863,308 (Qi). Further details regarding nonwoven abrasive articles can be found, for example, in U.S. Pat. No. 2,958,593 (Hoover et al.).

The present invention provides a method of abrading a surface, the method comprising contacting at least one composite particle according to the present invention, with a surface of a workpiece; and moving at least of one the composite particle or the contacted surface to abrade at least a portion of the surface with the composite particle. Methods for abrading with composite particles according to the present invention range of snagging (i.e., high pressure high stock removal) to polishing (e.g., polishing medical implants with coated abrasive belts), wherein the latter is typically done with finer grades (e.g., less ANSI 220 and finer) of abrasive particles. The composite particles may also be used in precision industrial and/or electronic abrading applications, such as grinding cam shafts with vitrified bonded wheels. The composite particles may also be used to finish hard substrates such as ceramics (e.g., sapphire, tungsten carbide, and zirconium oxide). The size of the composite particles used for a particular abrading application should be apparent to those skilled in the art.

Abrading with composite particles according to the present invention may be done dry (typically for low-energy applications such as lapping) or wet (typically for higher-energy applications). For wet abrading, the liquid may be introduced supplied in the form of a light mist to complete flood. Examples of commonly used liquids include: water, water-soluble oil, organic lubricant, and emulsions. The liquid may serve to reduce the heat associated with abrading and/or act as a lubricant. The liquid may contain minor amounts of additives such as bactericide, antifoaming agents, and the like.

Composite particles according to the present invention tend to be well suited to grind harder workpieces (e.g., hardened steel, tool steels, nickel-based superalloys), but they may find application to abrade workpieces such as aluminum metal, carbon steels, mild steels (e.g., 1018 mild steel and 1045 mild steel), tool steels, stainless steel, hardened steel, titanium, glass, ceramics, wood, wood-like materials (e.g., plywood and particle board), paint, painted surfaces, organic coated surfaces, and the like. Composite particles according to the present invention may also be used to abrade composites comprising hard particles dispersed in a softer matrix (or the converse). Bi-materials (e.g. cast iron liners in an aluminum matrix in aluminum engine blocks) may also be efficaciously ground using composite particles according to the present invention. The applied force during abrading typically ranges from about 1 to about 100 kilograms.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated. Oxides in abrasive particles are on a theoretical elemental oxide basis without regard to phases present. The experimental error in the tests was typically about ±5%.

### EXAMPLES

### Example 1

200/230 mesh (in accordance with ASTM (American Society for Testing Materials) E11-04 Standard) cubic boron nitride (cBN) particles (obtained from American Boarts Crushing Co. Inc, Boca Raton, Fla.) was provided to the Technical Institute of St. Petersburg, Russia for encapsulation in Al₂O₃. About forty grams of the cBN where encapsulated in Al₂O₃. The nominal thickness of the Al₂O₃ was about 200 nanometers on each cBN particle.

Two vitrified bonded grinding wheels was made from the Al₂O₃ coated cBN particles. The vitrified bonded grinding wheels were made by first making a wheel comprised, by volume, about 36% of the Al₂O₃ coated cBN particles, about 16% glass frit (aluminoborosilicate; obtained under the trade designation “NON-LEADED GLASS FG2349” from SuperAbrasive Techniques, Inc., Westerville, Ohio), about 14% hollow ceramic beads (obtained under the trade designation “SL-150” from PQ Corporation, Valley Forge, Pa.), 5% temporary binder, and about 29% porosity. The wheels were made by mixing the Al₂O₃ coated cBN particles, the glass frit, ceramic hollow beads, and a powdered phenol-aralkyl hexamine resin (obtained under the trade designation “SAT-939P RESIN BOND” from SuperAbrasive Techniques, Inc.). The mixture was thoroughly mixed and molded to form a wheel in a circular die. The temporary binder was cured at about 162° C. for about 30 minutes at a pressure of about 316 kg/cm² (4500 psi).

The wheel was then removed from the mold and placed in a refractory sagger (obtained from Ipsen Ceramic, Pecatonica, Ill.) and fired in a conventional box furnace (obtained under the trade designation “THERMOLYN 30400” from Thermolyne Corporation, Dubuque, Iowa). The furnace was heated to about 870° C. from room temperature (about 30° C.) at about 1.5° C./min; held at about 870° C. for about 3 hours; and then cooled to room temperature (about 30° C.) at about 2° C./min. The fired wheel had the following nominal dimensions, an outer diameter, inner diameter and thickness of about 38.6, 31.8, and 10.2 mm, (1.52, 1.25, and 0.4 inch), respectively. The wheel was then mounted on a core using an epoxy adhesive obtained under the trade designation “DP460” from the 3M Company, St. Paul, Minn. The core had an outer diameter of about 31.8 mm mm (1.25 inch) and a width of about 10.16 mm (0.4 inch). The Core was made of fiber glass reinforced phenolic pellets (obtained under the trade designation “LUBRICATED GLASS FILLED PHENOLIC MOLDING COMPOUND” from Resinoid Engineering Corporation, Skokie, Ill.). The core was formed in a steel mold having a cavity (outer diameter 31.8 mm (1.25 inch), inner diameter 9.53 mm (0.375 inch), and width of 10.16 mm (0.4 inch)) by heating it to a temperature of about 177° C. (350° F.) at a pressure of about 141 kg/cm² (2000 psi) for a period of about 30 minutes.

### Example 2

The two Example 2 vitrified bonded grinding wheels were made as described in Example 1, except the nominal thickness of Al₂O₃ was about 100 nanometers on each cBN particle.

### Example 3

The two Example 2 vitrified bonded grinding wheels were made as described in Example 1, except a TiO₂ coating was applied rather than the Al₂O₃ coating.

### Comparative Example A

Two Comparative Example A vitrified bonded grinding wheels were made as described for Example 1, except the cBN was not encapsulated with the Al₂O₃.

The grinding performance of the Example 1 and Comparative Example A grinding wheels were evaluated using a cylindrical grinder (obtained from The Cincinnati Milling Machine Company, Cincinnati, Ohio under the trade designation “CINCINNATI FILMATIC 10″ UNIVERSAL GRINDING MACHINE, MODEL DH”) on 4140 steel through hardened to about 60 HRc. The grinder was set to provide an infeed rate of about 7.6 micrometers/rev (0.0003 in./rev.), a workpiece speed of about 185 rpm, a wheel speed of about 2200 rpm, and a crossfeed of about 8.89 mm (0.35 inch). The grinding was conducted until a total of about 2.79 mm (0.11 inch) was infed from the diameter of the workpiece. Measurement of the workpiece and wheel diameters were conducted after every 0.254 mm (0.010 inch) infeed for the first ten infeed cycles.

Example 1 and Comparative Example A were tested again, except the size measurement interval was increased to 0.762 mm (0.03 inch) in order to obtain more significant (measurable) wear values. Examples 2 and 3 were also tested.

After each test, the test wheel and the workpiece diameters measured, and the G-ratio was calculated by dividing the workpiece volume loss by the test volume loss. All the measurements were done with digital micrometers obtained from American Mitutoyo Corporation, Aurora, Ill.

The results obtained from the tests conducted using dimension measurement interval after every infeed distance of 0.254 mm (0.01 inch) are reported in Table 1, below.

TABLE 1

| | |
|---|---|
| Infeed distance, mm | Wheel wear, mm (in.) |

| (in.) | Example 1 | Comparative Example A |
|---|---|---|
| 0.254 (0.01) | 0.005 (0.0002) | 0.015 (0.0006) |
| 0.508 (0.02) | 0.005 (0.0002) | 0.030 (0.0012) |
| 0.762 (0.03) | 0 | 0.046 (0.0018) |
| 1.016 (0.04) | 0 | 0.191 (0.0075) |
| 1.270 (0.05) | 0 | 0.258 (0.0102) |
| 1.524 (0.06) | 0.003 (0.0001) | 0.274 (0.0108) |
| 1.778 (0.07) | 0.005 (0.0002) | 0.274 (0.0108) |
| 2.032 (0.08) | 0 | 0.386 (0.0108) |
| 2.794 (0.11) | 0.005 (0.0002) | 0.030 (0.0012) |

The surface finish of workpieces from the grinding evaluations of Example 1 and Comparative Example A were measured using a surface profiler (obtained from Carl Zeiss, Inc., Thornwood, N.Y. under the trade designation “TSK ZEISS SURFCOM 30A”). The Rₐ for Example 1 and Comparative Example A was about 0.57 micrometer (22.42 microinches) and about 3.44 micrometers (135.45 microinches), respectively; and the Rₜ for Example 1 and Comparative Example A about 6.29 micrometers (247.54 microinches) and about 31.88 micrometers (1254.95 microinches), respectively.

The stock removed by Example 1, 2, and 3, and Comparative Example A obtained from the tests conducted using dimension measurement interval after every infeed distance of 0.762 mm (0.03 inch) are reported in Table 3, below.

TABLE 3

| | Stock Removed, cubic millimeters | | | |
|---|---|---|---|---|
| | | | | Comparative |
| Infeed (mm) | Example 1 | Example 2 | Example 3 | Example A |
| 0.76200 | 2126 | 1648 | 2668 | 2118 |
| 1.52400 | 2064 | 1611 | 1578 | 1474 |
| 2.28600 | 2004 | 1573 | 1155 | 964 |
| 3.81000 | 1860 | 2595 | 1721 | 1427 |
| Total | 8053 | 7427 | 7122 | 5983 |

The wheel wear (size change on the diameter) in Examples 1, 2, and 3, and Comparative Example A are reported in Table 4, below. These tests were conducted over infeed increments of about 762 micrometers (0.03 inch).

TABLE 4

| | Wheel Wear, mm | | | |
|---|---|---|---|---|
| Infeed | Example 1 | Example 2 | Example 3 | Comparative A |
| 0.762 | 0.001 | 0.023 | 0.053 | 0.210 |
| 1.524 | 0.010 | 0.045 | 0.104 | 0.133 |
| 2.286 | 0.017 | 0.032 | 0.163 | 0.379 |
| 3.810 | 0.031 | 0.065 | 0.169 | 0.131 |

The wheel volume wear in Examples 1, 2, and 3, and Comparative Example A are reported in Table 5, below. These tests were conducted over infeed increments of about 762 micrometers (0.03 inch).

TABLE 5

| | Wheel wear, cubic millimeters | | | |
|---|---|---|---|---|
| Infeed | Example 1 | Example 2 | Example 3 | Comparative A |
| 0.762 | 0.362 | 12.943 | 30.536 | 114.573 |
| 1.524 | 5.790 | 25.526 | 59.254 | 72.910 |
| 2.286 | 9.410 | 17.976 | 93.061 | 207.273 |
| 3.810 | 17.733 | 37.031 | 96.696 | 71.521 |
| Total | 33.295 | 93.476 | 279.547 | 466.278 |

The G-ratio (grinding ratio) in Examples 1, 2, and 3, and Comparative Example A are reported in Table 6, below. These tests were conducted over infeed increments of about 762 micrometers (0.03 inch). The G-ratio was calculated by dividing the workpiece volume ground by the test wheel volume lost. All the measurements were done with digital micrometers obtained from American Mitutoyo Corporation.

TABLE 6

| | G-Ratio | | | |
|---|---|---|---|---|
| Infeed | Example 1 | Example 2 | Example 3 | Comparative A |
| 0.762 | 5875 | 127 | 87 | 18 |
| 1.524 | 356 | 63 | 27 | 20 |
| 2.286 | 213 | 88 | 12 | 5 |
| 3.810 | 105 | 70 | 18 | 20 |
| Total G-ratio | 242 | 79 | 25 | 13 |

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A composite particle comprising a single abrasive grit having an outer surface, and a ceramic substantially covering the outer surface, wherein the abrasive grit has, at 400° C., a thermal conductivity of at least 0.03 cal/sec/cm/° C., wherein the ceramic has, in a range 400° C. to 1600° C., a thermal conductivity that is at least 50% less than the thermal conductivity of the abrasive grit, and wherein the ceramic has an average thickness in a range from 10 nm to 1000 nm.

2. The composite particle according to claim 1, wherein the single abrasive grit is selected from the group consisting of a boron nitride grit, a diamond grit, a boron nitride carbide, a polycrystalline diamond grit, and a polycrystalline cubic boron nitride grit.

3. The composite particle according to claim 1, wherein the single abrasive grit is one of a diamond abrasive grit or a cubic boron nitride abrasive grit.

4. The composite particle according to claim 1, wherein the ceramic is at least one of crystalline metal oxide or crystalline metal carbide.

5. The composite particle according to claim 1, wherein the single abrasive grit is one of a diamond abrasive grit or a cubic boron nitride abrasive grit, wherein the ceramic is at least one of crystalline metal oxide or crystalline metal carbide, and wherein the amount of ceramic is not greater than 5 percent by weight of the weight of the single abrasive grit.

6. The composite particle according to claim 1, wherein the ceramic has, in a range 400° C. to 1600° C., a thermal conductivity of not greater than 0.02 cal/sec/cm/° C.

7. The composite particle according to claim 1, wherein the ceramic has a thickness in a range from 10 nm to 200 nm.

8. The composite particle according to claim 1, wherein the abrasive grit having a thermal conductivity of at least 0.3 cal/sec/cm/° C.

9. The composite particle according to claim 1, wherein the amount of ceramic is not greater than 5 percent by weight of the weight of the single abrasive grit.

10. A plurality of the composite particles according to claim 1.

11. A plurality of abrasive grits having a specified nominal grade, wherein at least a portion of the abrasive grits is a plurality of composite particles according to claim 1.

12. The composite particle according to claim 11, wherein the amount of ceramic is not greater than 5 percent by weight of the weight of the single abrasive grit.

13. An abrasive article comprising binder and a plurality of composite particles according to claim 1 secured within the article by the binder.

14. The abrasive article according to claim 13, wherein the amount of ceramic is not greater than 5 percent by weight of the weight of the single abrasive grit.

15. A method for preparing a plurality of composite particles according to claim 1, the method comprising:
providing a abrasive grit having an outer surface, wherein the abrasive grit has, at 400° C., a thermal conductivity of at least 0.03 cal/sec/cm/° C.; and
applying a ceramic to substantially covering the outer surface to provide the composite particle.

16. The method according to claim 15, wherein applying the ceramic to the outer surface of the abrasive grit includes at least one of plasma spraying, fluidized bed coating, sputter coating, vapor deposition, or physical deposition.

17. The method according to claim 15, wherein the single abrasive grit is selected from the group consisting of a boron nitride grit, a diamond grit, a boron nitride carbide, a polycrystalline diamond, and a polycrystalline cubic boron nitride, and wherein the ceramic is at least one of crystalline metal oxide or crystalline metal carbide.

18. The method according to claim 17, wherein the ceramic has, in a range 400° C. to 1600° C., a thermal conductivity of not greater than 0.02 cal/sec/cm/° C.

19. A method for making an abrasive article, the method comprising:
applying a slurry comprising a plurality of composite particles according to claim 1 distributed within a binder precursor onto a major surface of a backing to provide a layer of the slurry; and
curing the binder precursor to provide the abrasive article.

20. A method for making an abrasive article, the method comprising:
applying a make layer onto a major surface of a backing;
at least partially embedding a plurality of composite particles according to claim 1 into the make layer;
at least partially curing the make layer;
applying a size layer at least partially covering the cured make layer; and
curing the size layer to provide the abrasive article.

21. A method of abrading a surface, the method comprising:
providing an abrasive article comprising a binder and a plurality of abrasive particles, wherein at least a portion of the abrasive particles is a plurality of composite particles according to claim 1;
contacting at least one of the composite particles with a surface of a workpiece; and
moving at least one of the contacted composite particles or the contacted surface to abrade at least a portion of the surface with the contacted composite particles.
